(19) United States
(12) Patent Application Publication
(10) Pub. No.: US 2014/0301736 A1
(43) Pub. Date: Oct. 9, 2014

(54) DIRECTLY MODULATED MULTI-LEVEL OPTICAL SIGNAL GENERATOR AND METHOD THEREOF

(71) Applicant: Electronics and Telecommunications Research Institute, Daejeon (KR)

(72) Inventors: Joon-Young HUH, Daejeon-si (KR); Joon-Ki LEE, Daejeon-si (KR); Sae-Kyoung KANG, Daejeon-si (KR); Kwang-Joon KIM, Daejeon-si (KR); Jong-Hyun LEE, Daejeon-si (KR)

(73) Assignee: Electronics and Telecommunications Research Institute, Daejeon (KR)

(21) Appl. No.: 14/180,798

(22) Filed: Feb. 14, 2014

(30) Foreign Application Priority Data
Apr. 9, 2013 (KR) 10-2013-0038806

(51) Int. Cl. H04B 10/516; H04B 10/2575

(52) U.S. Cl. CPC H04B 10/516; H04B 10/2575
USPC 398/115

(57) ABSTRACT

A directly modulated multi-level optical signal generator and a method thereof are provided. The multi-level optical signal generator includes N number of direct modulation lasers (DMLs) configured to directly modulate source light into a 2-level optical signal, and an optical power combiner configured to combine N number of 2-level optical signals directly modulated by the respective DMLs to generate a 2^{N}-level optical signal.

### CROSS-REFERENCE TO RELATED APPLICATION

This application claims the benefit under 35 U.S.C. §119(a) of a Korean Patent Application No. 10-2013-0038806, filed on Apr. 9, 2013, the entire disclosure of which is incorporated herein by reference for all purposes.

### BACKGROUND

1. Field

The following description relates to technology that converts an electrical signal into an optical signal in an optical transmitter used for optical communication.

2. Description of the Related Art

Due to the spread of smartphones and the introduction of a new networking service such as a social network, a network based on optical communication is being continuously required to become higher in speed and to be increased in capacity. In a backbone network for long-distance transmission, as a method for increasing a transmission capacity, there is a wavelength division multiplexing (WDM) scheme that multiplexes a plurality of wavelengths to transmit the multiplexed wavelengths through one optical fiber. Also, in addition to the WDM scheme, a method for increasing a transmission capacity per wavelength is being researched.

In current Ethernet, interest is being concentrated on a pulse amplitude modulation (PAM)-N (where N is an integer) optical signal in a multi-level scheme, for a next-generation communication network. The PAM-N optical signal is a scheme in which N number of levels are classified as intensities of optical signals. One of methods that generate a PAM-4 optical signal is a method that uses an optical source and an optical power modulator, and acquires the PAM-4 optical signal by applying an electrically generated signal having four levels to the optical power modulator. Such a method needs a device, such as a digital-to-analog converter (DAC), for converting an electrical 2-level signal into an electrical multi-level signal. The DAC should operate at a high speed so as to be applied to next-generation Ethernet optical transmission technology, and is expensive. At a current technology level, the DAC has many jitters and noises, and thus is not good in eye opening characteristic.

### SUMMARY

The following description relates to an apparatus and method that generate a multi-level optical signal by using a direct modulation scheme of an optical element such as a direct modulation laser without electrically generating the multi-level optical signal, in generating the multi-level optical signal.

In one general aspect, a multi-level optical signal generator includes: N number of direct modulation lasers (DMLs) configured to directly modulate source light into a 2-level optical signal; and an optical power combiner configured to combine N number of 2-level optical signals directly modulated by the respective DMLs to generate a 2^{N}-level optical signal.

The N DMLs may directly modulate the source light having different wavelengths, respectively. In this case, a wavelength interval between the source light directly modulated by the respective DMLs may be set greater than a bandwidth of an optical receiver that receives the 2^{N}-level optical signal generated by the optical power combiner. Alternatively, the source light directly modulated by the respective DMLs may be polarized, and the polarized optical signals may be vertical to each other.

The optical power combiner may combine the N 2-level optical signals directly modulated by the respective DMLs for optical intensities to have a ratio of 2^{N-1}: . . . :2¹:1, in combining optical signals.

According to another aspect, the multi-level optical signal generator may further include an optical attenuator disposed at a front stage or rear stage of each of the DMLs, and configured to attenuate an optical intensity in a corresponding path to attenuate the light such that optical intensities of the N 2-level optical signals inputted to the optical power combiner have a ratio of 2^{N-1}, . . . :2¹:1. In this case, the optical power combiner may combine the N 2-level optical signals attenuated by the optical attenuator for optical intensities of the respective optical signals to have a ratio of 1:1: . . . :1.

According to another aspect, each of the N DMLs may include a monitoring photodiode configured to adjust intensities of the optical signals combined by the optical power combiner.

Each of the N DMLs may directly modulate the source light into the 2-level optical signal by using the electrical 2-level signal. In this case, each of the N DMLs may directly modulate the source light into the 2-level optical signal by using an electrical 2-level signal with an adjusted amplitude, in which case each of the N DMLs may receive an electrical 2-level signal whose an amplitude level has been adjusted at a ratio of 1:½: . . . :½^{N-1}.

In another general aspect, a multi-level optical signal generating method includes: directly modulating source light into N number of 2-level optical signals by using N number of DMLs; and combining the N 2-level optical signals directly modulated by the respective DMLs using an optical power combiner to generate a 2^{N}-level optical signal.

Other features and aspects will be apparent from the following detailed description, the drawings, and the claims.

### BRIEF DESCRIPTION OF THE DRAWINGS

FIG. 1 is a block diagram illustrating a configuration of a multi-level optical signal generator according to a first embodiment of the present invention.

FIG. 2 is a reference diagram illustrating an example in which the multi-level optical signal generator according to the first embodiment of the present invention generates a PAM-4-level optical signal.

FIG. 3 is a block diagram illustrating a configuration of a multi-level optical signal generator according to a second embodiment of the present invention.

FIG. 4 is a block diagram illustrating a configuration of a multi-level optical signal generator according to a third embodiment of the present invention.

FIG. 5 is a block diagram illustrating a configuration of a multi-level optical signal generator according to a fourth embodiment of the present invention.

FIG. 6 is a flowchart illustrating a multi-level optical signal generating method according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, embodiments of the present invention will be described in detail with reference to the accompanying drawings. In the following description, when the detailed description of the relevant known function or configuration is determined to unnecessarily obscure the important point of the present invention, the detailed description will be omitted. Terms used herein are terms that have been defined in consideration of functions in embodiments, and the terms that have been defined as described above may be altered according to the intent of a user or operator, or conventional practice, and thus, the terms should be defined on the basis of the entire contents of this specification.

The present invention proposes technology in which a multi-level optical signal generator generates a multi-level optical signal by using an optical element such as a direct modulation laser (DML) without electrically generating the multi-level optical signal. The multi-level optical signal generator may be applied to an optical transmitter. The DML is a laser device that directly modulates source light to enable an output to be obtained. The DML may be replaced with an external modulation laser. Different from the DML, the external modulation laser is formed separately into a laser function and a modulation function.

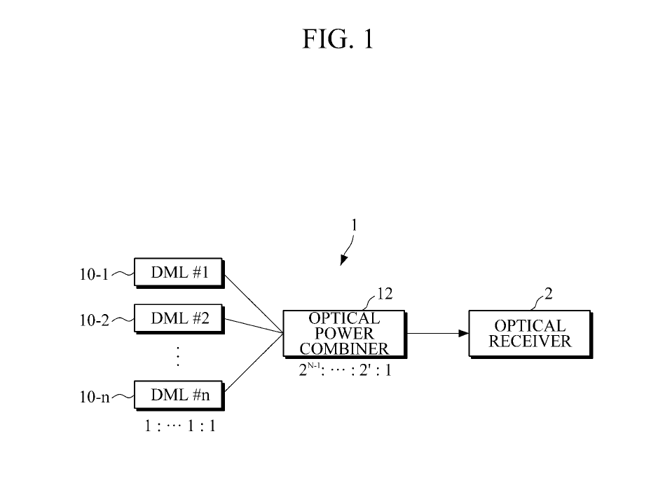

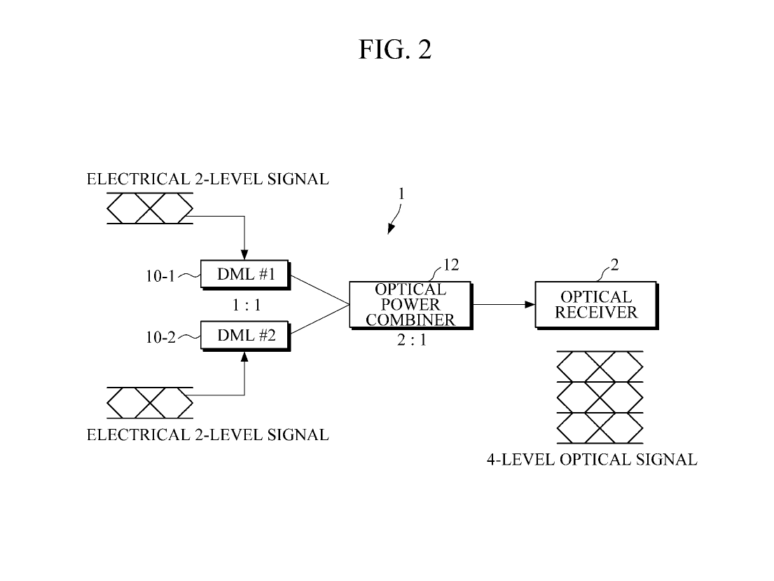

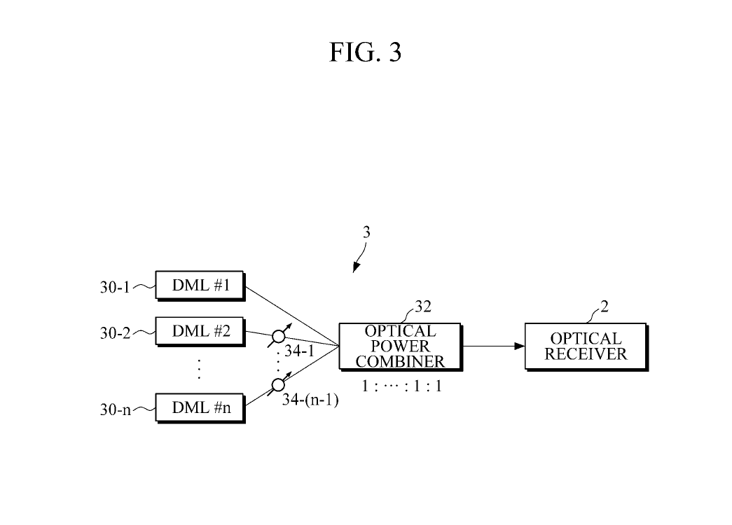

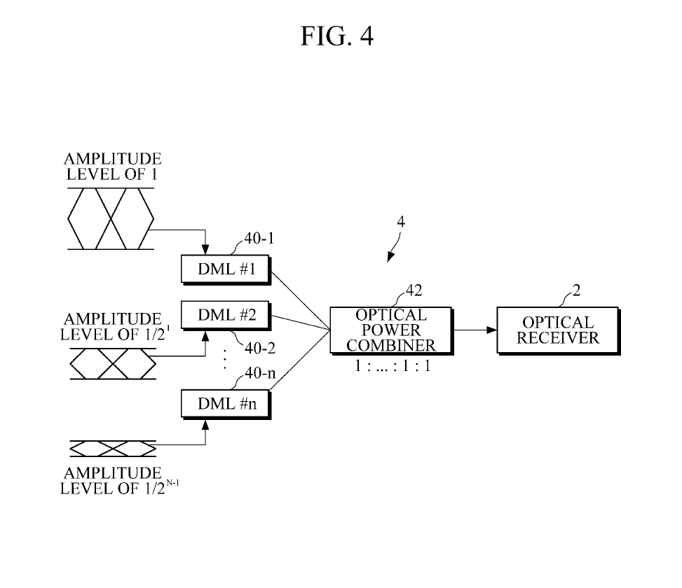

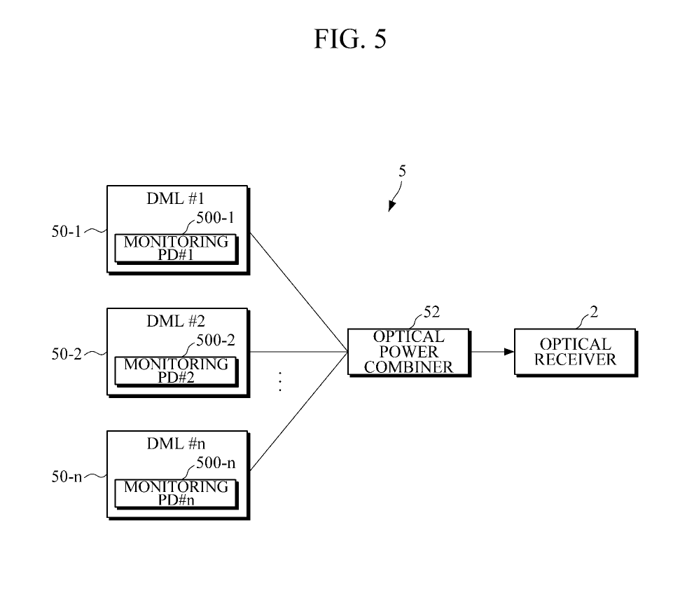

In order to generate the multi-level optical signal, the present invention uses a first method that uses the DML and an asymmetrical optical power combiner, a second method that uses the DML and an optical attenuator, a third method that adjusts an amplitude of an electrical signal inputted to the DML, and a fourth method that adjusts an optical intensity by using a monitoring photodiode (PD) of the DML. Hereinafter, the first method will be described with reference to FIGS. 1 and 2, the second method will be described with reference to FIG. 3, the third method will be described with reference to FIG. 4, and the fourth method will be described with reference to FIG. 5.

FIG. 1 is a block diagram illustrating a configuration of a multi-level optical signal generator 1 according to a first embodiment of the present invention.

Referring to FIG. 1, the multi-level optical signal generator 1 that generates a 2^{N}-level optical signal includes N number of DMLs 10-1 to 10-N and one optical power combiner 12.

Each of the N DMLs 10-1 to 10-N directly modulates source light into a 2-level optical signal to output the modulated optical signal. The optical power combiner 12 combines the 2-level optical signals directly modulated by the respective DMLs 10-1 to 10-N to generate a 2^{N}-level optical signal. At this time, for simple example, the optical power combiner 12 combines the 2-level optical signals directly modulated by the N DMLs 10-1 to 10-N in order for optical intensities to have a ratio of 2^{N-1}: . . . :2¹:1, in combining optical signals.

In the directly modulated signals, interference occurs depending on a phase relationship in the same wavelength or a proximal wavelength. Therefore, according to the present invention, (1) an appropriate difference is set between wavelengths, (2) a separately provided apparatus using polarization changes polarization between wavelengths, or (3) a phase relationship between the N DMLs 10-1 to 10-N is adjusted. For example, the N DMLs 10-1 to 10-N directly modulate source light having different wavelengths. In this case, a wavelength interval between the source light directly modulated by the N DMLs 10-1 to 10-N is set greater than a bandwidth of an optical receiver. For another example, the source light directly modulated by the N DMLs 10-1 to 10-N is polarized by a polarization apparatus to have different polarization characteristics. At least one or more of the above-described wavelength adjustment methods may be used in combination, and the above-described wavelength adjustment methods are essential to implement the present invention. A wavelength adjustment principle between the source light of the N DMLs 10-1 to 10-N will be described below in detail with reference to FIG. 2.

The optical power combiner 12 combines the 2-level optical signals directly modulated by the N DMLs 10-1 to 10-N in order for optical intensities to have a ratio of 2^{N-1}: . . . :2¹:1, in combining optical signals. Thus, a 2^{N}-level optical signal is generated, and an optical receiver 2 receives the 2^{N}-level optical signal. The optical receiver 2 may be configured with a PD. The optical power combiner 12 is configured with N number of input ports and one output port, and combines optical signals respectively inputted to the input ports in order for optical intensities of the respective optical signals to have a ratio of 2^{N-1}: . . . :2¹:1. In real implementation, an optical intensity combination ratio cannot accurately be adjusted, and thus may have an approximate value.

FIG. 2 is a reference diagram illustrating an example in which the multi-level optical signal generator 1 according to the first embodiment of the present invention generates a PAM-4-level optical signal.

Referring to FIG. 2, the multi-level optical signal generator 1 includes two DMLs 10-1 and 10-2 and the optical power combiner 12 that combines optical signals so as to have optical intensities at a ratio of 2:1.

Optical signals, into which electrical 2-level signals are directly modulated by the two DMLs 10-1 and 10-2, are combined by the 2:1 optical power combiner 12, and thus, a PAM-4-level optical signal is generated. To provide a theoretical analysis on this, an optical signal modulated by the DML #1 10-1 may be expressed as Equation (1), and an optical signal modulated by the DML #2 10-2 may be expressed as Equation (2).

E₁=A₁exp[−i(w₁t+Φ₁)] (1)

E₂=A₂exp[−i(w₂t+Φ₂)] (2)

where E denotes an electric field, A denotes data, w denotes a wavelength of laser, and Φ denotes a phase.

When the two modulated signals are received by the optical receiver 2, the received optical signals may be expressed as Equation (3). The optical receiver 2 may be configured with a PD.

$$\begin{matrix}{P}_{rec} = K {\vert {E}_{1} + {E}_{2} \vert}^{2} \\ = {KA}_{1}^{2} + {KA}_{2}^{2} + 2 {KA}_{1} {A}_{2} cos [ ( {w}_{1} - {w}_{2} ) t + {φ}_{1} - {φ}_{2} ]\end{matrix} \qquad ( 3 )$$

where K denotes a constant of the PD.

According to an embodiment, in Equation (3), when a bandwidth of the optical receiver 2 is set less than a frequency interval between the DML #1 10-1 and the DML #2 10-2, a third term is removed, and thus a PAM-4 signal can be acquired. Therefore, wavelength intervals of DMLs is adjusted greater than a bandwidth of the PD which is used for receiving the wavelengths, and thus, as illustrated in FIG. 2, a clear PAM-N signal can be acquired.

According to another embodiment, in Equation (3), the third term can be offset by a certain degree by adjusting polarization of a DML.

Hereinafter, the principle that generates a PAM-4 optical signal by using the two DMLs 10-1 and 10-2 will be described with reference to FIG. 2.

An electrical 2-level signal is inputted to each of the DMLs 10-1 and 10-2, which directly modulates source light into a 2-level optical signal by using the input electrical 2-level signal and outputs the modulated optical signal. The 2-level optical signals outputted from the respective DMLs 10-1 and 10-2 are combined into one signal by the optical power combiner 12, and since optical intensities are allocated at a ratio of 2:1, the optical power combiner 12 outputs an optical signal divided into four levels.

Specifically, it is assumed that a pattern of 1100 is applied as an electrical 2-level signal to the DML #1 10-1, and a pattern of 1010 is applied as an electrical 2-level signal to the DML #2 10-2. Since the optical power combiner 12 has a combination ratio of 2:1, an optical intensity of an optical signal which is outputted through the DML #1 10-1 and the optical power combiner 12 is two times greater than an optical intensity of an optical signal which is outputted through the DML #2 10-2 and the optical power combiner 12, and thus, a pattern of 2200 and the pattern of 1010 are optically added. As a result, the optical power combiner 12 outputs a pattern of 3210.

FIG. 3 is a block diagram illustrating a configuration of a multi-level optical signal generator 3 according to a second embodiment of the present invention.

Referring to FIG. 3, the multi-level optical signal generator 3 that generates a 2^{N}-level optical signal includes N number of DMLs 30-1 to 30-N, one optical power combiner 32, and N−1 number of optical attenuators 34-1 to 34-(N−1).

Each of the N DMLs 30-1 to 30-N directly modulates source light into a 2-level optical signal to output the modulated optical signal. Each of the N−1 optical attenuators 34-1 to 34-(N−1) is disposed at a front stage or rear stage of a corresponding DML among the N DMLs 30-1 to 30-N, and attenuates an optical intensity of light in a corresponding path such that optical intensities of a plurality of 2-level optical signals inputted to the optical power combiner 32 have a ratio of 2^{N-1}: . . . :2¹:1.

According to an embodiment, the optical attenuator #1 34-1 attenuates an optical intensity of an optical signal by 3 dB, the optical attenuator #2 34-2 attenuates an optical intensity of an optical signal by 6 dB, and the optical attenuator #N−1 34-(N−1) attenuates an optical intensity of an optical signal by 3(N−1) dB. As illustrated in FIG. 3, each of the optical attenuators 34-1 to 34-(N−1) may be disposed at a rear stage of a corresponding DML among the N−1 DMLs 30-2 to 30-N, or each of the optical attenuators 34-1 to 34-(N−1) may be disposed at a front stage of a corresponding DML among the N−1 DMLs 30-2 to 30-N, even in which case each optical attenuator performs the same function. In real implementation, an attenuation amount of optical intensities of the optical attenuators 34-1 to 34-(N−1) cannot accurately be adjusted, and thus may have an approximate value. The optical power combiner 32 combines a plurality of 2-level optical signals optically attenuated by the respective optical attenuators 34-1 to 34-(N−1) to generate a 2^{N}-level optical signal. The optical power combiner 32 is configured with N number of input ports and one output port, and combines optical signals respectively inputted to the input ports in order for optical intensities of the respective optical signals to have a ratio of 1:1: . . . :1.

FIG. 4 is a block diagram illustrating a configuration of a multi-level optical signal generator 4 according to a third embodiment of the present invention.

Referring to FIG. 4, the multi-level optical signal generator 4 generates a 2^{N}-level optical signal through a scheme that adjusts an amplitude of an electrical signal. According to an embodiment, when an amplitude level of an electrical 2-level signal applied to a DML #1 40-1 is 1, an electrical 2-level signal having an amplitude level corresponding to ½¹ of the amplitude level of the electrical 2-level signal applied to the DML #1 40-1 is applied to a DML #2 40-2, and an electrical 2-level signal having an amplitude level corresponding to ½^{N-1} of the amplitude level of the electrical 2-level signal applied to the DML #1 40-1 is applied to a DML #N 40-N. At this time, each of N number of DMLs 40-1 to 40-N directly modulates source light into a 2-level optical signal by using the electrical 2-level signal. Subsequently, the 2-level optical signals respectively outputted from the N DMLs 40-1 to 40-N are inputted to an optical power combiner 42. The optical power combiner 42 is configured with N number of input ports and one output port, and combines optical signals respectively inputted to the input ports in order for optical intensities of the respective optical signals to have a ratio of 1:1: . . . :1. In real implementation, a division and combination ratio cannot accurately be adjusted due to a characteristic of the N DMLs 40-1 to 40-N, and thus may have an approximate value. When a threshold current of each of the N DMLs 40-1 to 40-N is sufficiently lower than an applied electrical signal, a division and combination ratio can be accurately adjusted. In the embodiments described above with reference to FIGS. 2 to 4, at least one or more embodiments may be used in combination.

FIG. 5 is a block diagram illustrating a configuration of a multi-level optical signal generator 5 according to a fourth embodiment of the present invention.

Referring to FIG. 5, N number of monitoring PDs 500-1 to 500-N are respectively built into N number of DMLs 50-1 to 50-N, and thus the multi-level optical signal generator 5 can generate the optimal multi-level optical signal. That is, the multi-level optical signal generator adjusts optical intensities of optical signals which are inputted to an optical power combiner 52 through the respective monitoring PDs 500-1 to 500-N.

As described above with reference to FIGS. 1 to 5, the four methods that optically generate a multi-level signal have been described separately, but are not limited thereto. For another example, different methods may be appropriately combined to generate a multi-level optical signal.

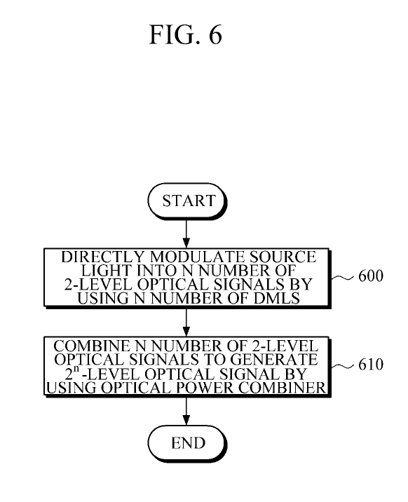

FIG. 6 is a flowchart illustrating a multi-level optical signal generating method according to an embodiment of the present invention.

Referring to FIG. 6, the multi-level optical signal generator directly modulates source light into a plurality of 2-level optical signals by using N number of DMLs in operation 600. Subsequently, the optical power combiner combines the plurality of 2-level optical signals directly modulated by the respective DMLs to generate a 2^{N}-level optical signal in operation 610.

In operation 600 of directly modulating the source light, the multi-level optical signal generator may directly modulate source light having different wavelengths by using the respective DMLs. A wavelength interval between the source light directly modulated by the respective DMLs may be preferably greater than the bandwidth of the optical receiver. In operation 600 of directly modulating the source light, the source light directly modulated by the respective DMLs may be polarized, and the polarized optical signals may be vertical to each other.

In operation 610 of generating the 2^{N}-level optical signal, the multi-level optical signal generator may combine the plurality of 2-level optical signals directly modulated by the N DMLs in order for optical intensities to have a ratio of 2^{N-1}: . . . :2¹:1, in combining optical signals by using the optical power combiner.

According to an embodiment, the multi-level optical signal generating method may further include an operation that attenuates an optical intensity of light in a corresponding path by using the optical attenuator disposed at a front stage or rear stage of a corresponding DML among the N DMLs, and attenuates the light such that optical intensities of the plurality of 2-level optical signals inputted to the optical power combiner have a ratio of 2^{N-1}: . . . :2¹:1. At this time, in operation 610 of generating the 2^{N}-level optical signal, the multi-level optical signal generator combines the plurality of 2-level optical signals attenuated by the respective optical attenuators in order for optical intensities of the respective optical signals to have a ratio of 1:1: . . . :1.

According to an embodiment, in operation 600 of directly modulating the source light, the multi-level optical signal generator may adjust the optical intensities of the respective optical signals combined by the optical power combiner, by using the monitoring PDs built in the respective DMLs.

According to an embodiment, in operation 600 of directly modulating the source light, the multi-level optical signal generator may receive an electrical 2-level signal, and directly modulate source light into a 2-level optical signal by using the received electrical 2-level signal.

According to an embodiment, in operation 600 of directly modulating the source light, the multi-level optical signal generator may receive an electrical 2-level signal with an adjusted amplitude, and directly modulate the source light into the 2-level optical signal by using the electrical 2-level signal with the adjusted amplitude.

Generally, in optical transmission, an electrical multi-level signal should be first generated for generating a multi-level optical signal, and an element such as the DAC is required for generating the electrical multi-level signal. The field requiring the multi-level optical signal is a field requiring a speed of 25 Gb/s or more, and since the DAC that operates at a high speed is expensive, it is difficult to use the DAC. At the current technology level, the DAC has many jitters and noises, and thus is not good in eye opening characteristic.

However, according to the present invention, a multi-level optical signal is generated by a direct modulation scheme using an optical element such as the DML without electrically generating the multi-level optical signal, in generating the multi-level optical signal. Accordingly, the multi-level optical signal can be generated using an optical element such as the low-cost DML, and an eye opening characteristic can be enhanced. Also, by using a process such as silicon photonics, a product size can be miniaturized, and the low cost can be achieved.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-level optical signal generator, comprising:
N number of direct modulation lasers (DMLs) configured to directly modulate source light into a 2-level optical signal; and
an optical power combiner configured to combine N number of 2-level optical signals directly modulated by the respective DMLs to generate a 2^{N}-level optical signal.

2. The multi-level optical signal generator of claim 1, wherein the N DMLs directly modulate the source light having different wavelengths, respectively.

3. The multi-level optical signal generator of claim 2, wherein a wavelength interval between the source light directly modulated by the respective DMLs is set greater than a bandwidth of an optical receiver that receives the 2^{N}-level optical signal generated by the optical power combiner.

4. The multi-level optical signal generator of claim 1, wherein the source light directly modulated by the respective DMLs is polarized, and the polarized optical signals are vertical to each other.

5. The multi-level optical signal generator of claim 1, wherein the optical power combiner combines the N 2-level optical signals directly modulated by the respective DMLs for optical intensities to have a ratio of 2^{N-1}: . . . :2¹:1, in combining optical signals.

6. The multi-level optical signal generator of claim 1, further comprising an optical attenuator disposed at a front stage or rear stage of each of the DMLs, and configured to attenuate an optical intensity in a corresponding path to attenuate the light such that optical intensities of the N 2-level optical signals inputted to the optical power combiner have a ratio of 2^{N-1}: . . . :2¹:1,
wherein the optical power combiner combines the N 2-level optical signals attenuated by the optical attenuator for optical intensities of the respective optical signals to have a ratio of 1:1: . . . :1.

7. The multi-level optical signal generator of claim 1, wherein each of the N DMLs comprises a monitoring photodiode configured to adjust intensities of the optical signals combined by the optical power combiner.

8. The multi-level optical signal generator of claim 1, wherein each of the N DMLs directly modulates the source light into the 2-level optical signal by using the electrical 2-level signal.

9. The multi-level optical signal generator of claim 8, wherein each of the N DMLs directly modulates the source light into the 2-level optical signal by using an electrical 2-level signal with an adjusted amplitude.

10. The multi-level optical signal generator of claim 9, wherein each of the N DMLs receives an electrical 2-level signal whose an amplitude level has been adjusted at a ratio of 1:½: . . . :½^{N-1}.

11. A multi-level optical signal generating method, comprising:
directly modulating source light into N number of 2-level optical signals by using N number of direct modulation lasers (DMLs); and
combining the N 2-level optical signals directly modulated by the respective DMLs using an optical power combiner to generate a 2^{N}-level optical signal.

12. The multi-level optical signal generating method of claim 11, wherein the directly modulating of source light comprises directly modulating the source light having different wavelengths using the DMLs.

13. The multi-level optical signal generating method of claim 12, wherein in the directly modulating of source light, a wavelength interval between the source light directly modulated by the respective DMLs is set greater than a bandwidth of an optical receiver.

14. The multi-level optical signal generating method of claim 11, wherein in the directly modulating of source light, the source light directly modulated by the respective DMLs is polarized, and the polarized optical signals are vertical to each other.

15. The multi-level optical signal generating method of claim 11, wherein the generating of a 2^{N}-level optical signal comprises combining the N 2-level optical signals directly modulated by the respective DMLs for optical intensities to have a ratio of 2^{N-1}: . . . :2¹:1, in combining optical signals using the optical power combiner.

16. The multi-level optical signal generating method of claim 11, further comprising attenuating an optical intensity in a corresponding path to attenuate the light such that optical intensities of the N 2-level optical signals inputted to the optical power combiner have a ratio of 2^{N-1}: . . . :2¹:1, by using an optical attenuator disposed at a front stage or rear stage of each of the DMLs,
wherein the generating of a 2^{N}-level optical signal comprises combining the N 2-level optical signals attenuated by the optical attenuator for optical intensities of the respective optical signals to have a ratio of 1:1: . . . :1.

17. The multi-level optical signal generating method of claim 11, wherein the directly modulating of source light comprises adjusting intensities of the optical signals combined by the optical power combiner by using a monitoring photodiode built in each of the DMLs.

18. The multi-level optical signal generating method of claim 11, wherein the directly modulating of source light comprises:
receiving an electrical 2-level signal; and
directly modulating the source light into the 2-level optical signal by using the received electrical 2-level signal.

19. The multi-level optical signal generating method of claim 11, wherein the directly modulating of source light comprises:
receiving an electrical 2-level signal with an adjusted amplitude; and
directly modulating the source light into the 2-level optical signal by using the electrical 2-level signal with the adjusted amplitude.
